(19) United States
(12) Patent Application Publication
(10) Pub. No.: US 2008/0162109 A1
(43) Pub. Date: Jul. 3, 2008

(54) CREATING AND MANAGING A POLICY CONTINUUM

(75) Inventors: John C. Strassner, North Barrington, IL (US); David L. Raymer, Watauga, TX (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: Motorola, Inc., Schaumburg, IL (US)

(21) Appl. No.: 11/617,369

(22) Filed: Dec. 28, 2006

(51) Int. Cl. G06F 17/20; G06F 7/60

(52) U.S. Cl. 704/1; 703/2; 704/4

(57) ABSTRACT

A method and system for managing a policy includes a memory adapted to store at least one policy, residing at a first abstraction level, where each policy includes a plurality of language elements in a first vocabulary set and a processor communicatively coupled to the memory and adapted to perform semantic resolution using a set of ontologies by mapping at least one of the language elements in the first vocabulary set to at least one of a plurality of language elements in a second vocabulary set, the second vocabulary set having at least one of a different grammar and a different vocabulary from the first vocabulary set create a second policy, in response to the semantic resolution.

### FIELD OF THE INVENTION

This invention relates in general to policy management and network management and more particularly to relates to creation and translation of policies into forms appropriate for differing layers of a policy continuum within a network.

### BACKGROUND OF THE INVENTION

Fundamentally, different types of people, having different responsibilities and different functions in the organization, use policy for different reasons. For example, different constituencies (e.g., business analysts and programmers) have different grammars and vocabularies, making it very difficult for them to collaborate on a common product, project, or process. Business people don't want to express their policies in networking terminology, because network terminology is not needed to express their requirements. Similarly, networking people don't want policies written using business concepts, because these concepts are usually not precise enough to enable them to program the devices that they are managing. However, both business and network personnel must work together to ensure that network services are managed according to the business goals of the organization. What's needed, then, is a system that can define a set of policies that represent the needs of each constituency as well as support the translation between policies written for different constituencies, thereby forming a continuum of policies.

The representation of and translation between different types of policies is called the “Policy Continuum,” an example of which is shown in FIG. 1. Each level 1-5 in the policy continuum 100 addresses a specific type of user that has a very specific understanding of the managed entities operating at that particular level of abstraction.

As can be seen in FIG. 1, the policy continuum 100 is made up of five levels 1-5. Each level addresses a different type of user that has a different understanding of the shared entities operating at that particular level of abstraction. For example, the business view provides a description of business entities, such as customer, service, and Service Level Agreement (SLA), in business terms. The system view uses these same entities, but adds detail that is not appropriate at the business level. In addition, the system level may introduce additional entities to support one or more business processes defined at the business level.

This leads to the concept of “policy coherency.” Since different people have different ideas of what a policy is and what it is telling them, there exists a need to be able to translate between different levels of abstraction. For example, there is a need to be able to tie the high-level specification of a VPN (i.e., a virtual private network, an environment that supports private communications over a public infrastructure, where access is controlled to enable peer communications only within a defined community of interest) to an implementation approach (i.e., what type of VPN are we going to implement with which particular set of commands—e.g., Simple Network Management Protocol (SNMP) or Command Line Interface (CLI)). This means that the shared data must be of a form that facilitates syntactic adaptation and/or semantic mediation between the different levels.

Syntactic adaptation means that we define a mechanism that translates from one representation using a particular syntax to another representation that uses a different syntax. Adaptation, therefore, is the process of translating from a value provided in one syntactical form to an equivalent value in a different syntactical form. Mediation is (for purposes of the present discussion) the use of a common information model that enables equivalent semantic mapping between two concepts. Whereas adaptation is concerned just with the translating of one value to another value, mediation is concerned with the translating of concepts, and hence, the behavior, of what is being managed.

Hence, there is a need to represent and translate the behavior of a policy at one level of abstraction (i.e., a particular continuum level) to a different level of abstraction. This in turn requires the detection of syntactic (e.g., grammatical and sentence structure) and semantic (e.g., behavioral) inconsistencies between a set of policies and correct them.

Directory Enabled Networks, John C. Strassner, Macmillan Technical Publishing, 1999, ISBN 1-57870-140-6, and Policy-Based Network Management, John C. Strassner, Morgan Kaufmann Publishers, 2003, ISBN 1-55860-859-1, the contents of which are hereby incorporated by reference, define and describe the idea of a policy continuum. However, they do not offer a way to construct the policy continuum, or to transform one policy into multiple policies at different levels of the policy continuum. They also do not provide a way of modifying policies that make up an existing policy continuum. Finally, they do not offer a way of detecting syntactic and/or semantic conflicts between different policies in different layers of the policy continuum.

Therefore, a need exists to overcome the problems with the prior art as discussed above.

### SUMMARY OF THE INVENTION

A method and system are disclosed for managing a policy, where the method includes accessing at least one policy, residing at a first abstraction level, where each policy includes a plurality of language elements in a first vocabulary set. Semantic resolution is then performed using a set of ontologies by mapping at least one of the language elements in the first vocabulary set to at least one of a plurality of language elements in a second vocabulary set, the second vocabulary set having at least one of a different grammar and a different vocabulary from the first vocabulary set. In response to the semantic resolution, a second policy is created that is related to the first policy.

In accordance with an added feature of the invention, syntactic resolution is performed by mapping at least one of the language elements in the first vocabulary set to at least one of the language elements in the second vocabulary set using an information model associated with both the policy and the language elements in each of the first vocabulary set and the second vocabulary set.

In accordance with an additional feature of the invention, syntactic resolution is performed by mapping at least one of the language elements in the first vocabulary set to at least one of the language elements in the second vocabulary set using a data model associated with both the policy as well as the language elements in each of the first vocabulary set and the second vocabulary set.

In accordance with an additional feature of the invention, syntactic resolution is performed by mapping at least one of the language elements in the first vocabulary set to at least one of the language elements in the second vocabulary set using two or more data models associated with both the policy as well as the language elements in each of the first vocabulary set and the second vocabulary set; the differing definitions found in the two or more data models are resolved using the single information model.

In accordance with an additional feature of the invention, semantic resolution is performed by mapping at least one of the language elements in the first vocabulary set to at least one of the language elements in the second vocabulary set using two or more data models associated with both the policy as well as the language elements in each of the first vocabulary set and the second vocabulary set; the differing definitions found in the two or more data models are resolved using the single information model in conjunction with one or more ontologies.

In accordance with an additional feature of the invention, semantic resolution is performed by mapping at least one of the language elements in the first vocabulary set to at least one of the language elements in the second vocabulary set using two or more data models associated with both the policy as well as the language elements in each of the first vocabulary set and the second vocabulary set; the differing definitions found in the two or more data models are resolved using the combination of information model and ontologies, the latter of which are used to reason about the facts supplied by the information model and data models.

In accordance with yet another feature of the invention, the semantic resolution includes assigning at least one subset of the language elements in the second vocabulary set to a new policy residing at one of the first abstraction level, the second abstraction level, or a third abstraction level, thereby splitting an existing policy into two policies.

In accordance with yet a further feature of the invention, the semantic resolution includes using at least one of a matching function and a semantic equivalence function, wherein the matching function is based on one or more of syntax, keywords, metadata, and other language elements, that identifies words and phrases in a language that the policy uses with model elements from at least one of an information and a data model and concepts in the set of ontologies. Furthermore, the semantic equivalence function produces a ratioed result, thereby enabling different matches to be placed in rank-order. The semantic resolution provides preferred choices from the vocabulary used in the policy.

In accordance with still a further feature of the invention, a method for managing a policy includes modeling at least a first set of policies, all at one policy continuum level, as a set of mathematical operations that describe possible computations of each of the first set of policies and modeling at least a second set of policies, all at a different policy continuum level than that of the first set of policies, as a set of mathematical operations that describe possible computations of each of the second set of policies. The method also includes analyzing both the first set of policies and the second set of policies to ensure that a mapping between the mathematical operations of the first set of policies and the mathematical operations of the second set of policies exists without producing a conflict therebetween.

In accordance with an additional feature of the invention, a system for managing a policy includes a memory adapted to store at least one policy, residing at a first abstraction level, where each policy includes a plurality of language elements in a first vocabulary set. A processor communicatively coupled to the memory is adapted to perform semantic resolution using a set of ontologies by mapping at least one of the language elements in the first vocabulary set to at least one of a plurality of language elements in a second vocabulary set, the second vocabulary set having at least one of a different grammar and a different vocabulary from the first vocabulary set and create a second policy, in response to the semantic resolution.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 representative diagram of a policy continuum, according to an embodiment of the present invention;

FIG. 2 is a flowchart illustrating one approach to policy continuum creation, according to an embodiment of the present invention;

FIG. 3 is a representational diagram of a semantic resolution algorithm, according to an embodiment of the present invention;

FIG. 4 is a flowchart of a policy management approach, according to an embodiment of the present invention;

FIG. 5 is a flowchart of semantic analysis, according to an embodiment of the present invention;

FIG. 6 is a block diagram illustrating a policy-based system, according to an embodiment of the present invention; and

FIG. 7 is a high level block diagram of the policy server of FIG. 6, according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The present invention solves the limitations defined in the prior-art by using syntactic and semantic analyses to translate a policy into different forms, each form being appropriate for a specific layer of the policy continuum. The syntactic and semantic analyses are provided by a novel set of mechanisms that solve these problems by using a combination of information and data models, ontologies, and policy management.

As will be described in more detail below, an embodiment of the present invention accepts one or more policies and assigns each policy to one of a plurality of levels in a policy continuum, for example, one of the five levels of policy continuum 100, shown in FIG. 1. This is done by first dividing the policy into a set of policy statements and then, for each policy statement, comparing the language elements used in that policy statement with known objects present in the information model and ontologies that are used. An ontology is a formal, explicit specification of a shared, machine-readable vocabulary and meanings, in the form of various entities and relationships between them, to describe knowledge about the contents of one or more related subject domains throughout the life cycle of its existence. These entities and relationships are used to represent knowledge in the set of related subject domains. Formal refers to the fact that the ontology should be representable in a formal grammar. Explicit means that the entities and relationships used, and the constraints on their use, are precisely and unambiguously defined in a declarative language suitable for knowledge representation. Shared means that all users of an ontology will represent a concept using the same or equivalent set of entities and relationships. Subject domain refers to the content of the universe of discourse being represented by the ontology.

The process of comparing the language elements can be iterative, and may in some cases require multiple passes through the information and ontology mapping logic and appropriate semantic processing logic to verify that each policy statement (and hence each policy) is correctly constructed and has no syntactic or semantic problems. Once the policy is verified as having no inherent ambiguities or problems, it is then analyzed and assigned to a particular level of the policy continuum.

The present invention is directed toward constructing a policy continuum. It does not address creating policies (except in the case where an existing policy that contains grammatical elements belonging to two or more different policy continuum levels is split into two or more policies, as will be described below). The policy continuum can also be used as a framework to provide editing and policy creation views to various policy authors.

Policy Continuum Creation

The information and ontology models represent facts and the generalization of facts into concepts, respectively. Since these are necessarily two different ideas, they are stored in separate repositories using different representations. However, both formats (i.e., objects, relationships, and other model constructs) are converted into an equivalent XML form prior to the start of the process to enable the knowledge that they represent to be integrated.

Referring now to FIG. 2, a process flowchart of a policy continuum creation process, according to an embodiment of the present invention, is shown. The process begins at step 200 and moves directly to step 202, where a first policy is loaded into a processing system, such as that shown in FIG. 7, useful for implementing the present invention. The process moves to step 204, where noise words are removed from the policy and the policy is transformed into an XML representation. Knowledge from the model repositories as well as the ontology repositories is also converted to XML. Hence, knowledge from both repository types can be compared to the policy. Noise words are language elements that are present only for the purpose of making it easier for certain constituencies to understand a word or phrase, but don't change the nature of it. For instance, in the sentence “Mary has just retrieved 10 records,” “has” and “just” are noise words.

In order to create a policy continuum, each policy must first be checked for syntactic, semantic, and knowledge problems before it can be assigned to a particular level of the policy continuum. In the next step, 206, an analysis is performed to determine any and all syntactic problems. A syntactic problem is defined as a violation of the vocabulary and/or structural rules defined for the policy language. This decision can be thought of as checking for a match between non-noise words of the policy statement and model elements in the DEN-ng information model.

The set of DEN-ng languages are, by definition, well-formed, as they are derived from a set of verifiable models and defined using a context free grammar. This applies for any allowable policy statement as well (since a policy statement is part of a policy). However, this process divides the policy into a set of policy statements in order to ensure that there are no semantic problems or ambiguities between policy statements of the same policy. This stage uses the information model and one or more ontologies to identify problems having to do with the structure of the policy and vocabulary used, using a plurality of techniques including pattern matching. Specifically, the elements of the policy language are directly or indirectly associated with model elements (e.g., classes, attributes, and relationships) in the DEN-ng model. (Note that another model could be used, but it must have equivalent or greater functionality and expressiveness as the DEN-ng model, which is a preferred embodiment of this invention.) Hence, this stage consists of matching and/or translating language elements to the information model.

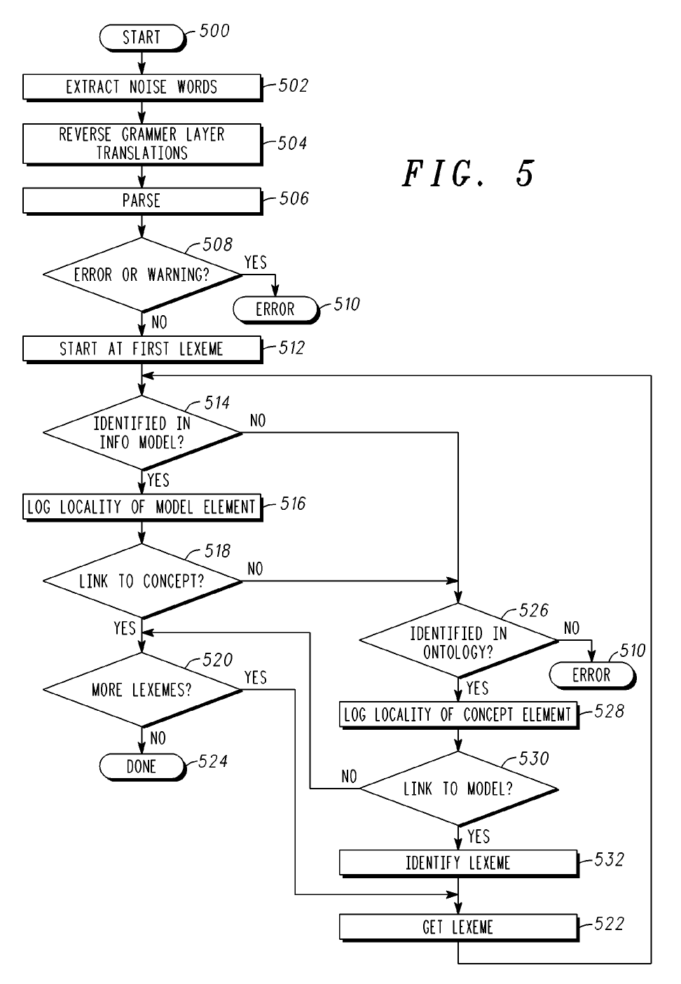

If a difference is detected between a model element and a language element in the policy statement, then a syntactic resolution process is invoked in step 208. This process views the DEN-ng model elements as the ultimate source of truth, and attempts to correct the language representation by changing it to match the knowledge defined in the DEN-ng model. If this cannot be done, as is determined in step 210, the mechanism terminates with an error at step 218. Note that if any one policy statement causes this process to terminate with an error, then the entire policy is marked as invalid. Otherwise (i.e., for both the case of exactly matching and not matching a language element with a model element), and also for the case where no syntactic problems are found in step 206, the process then checks, in step 212, for semantic problems. Note that step 212 is further detailed in FIG. 5.

Semantic problems indicate a mismatch in the behavior that the policies will assert. For example, the two policy actions “John gets Gold Service” and “Assign FTP to Bronze Service” are each valid actions in their own right, but present a semantic conflict if John sends FTP. (Note that this is not a problem of intent, since intent means “the planning or desire to perform an act”. Rather, it is a semantic conflict because if the semantics were clearer, then there wouldn't be a problem. In other words, just because FTP was assigned to Bronze Service does not rule out the possibility that Gold Service also includes FTP.)

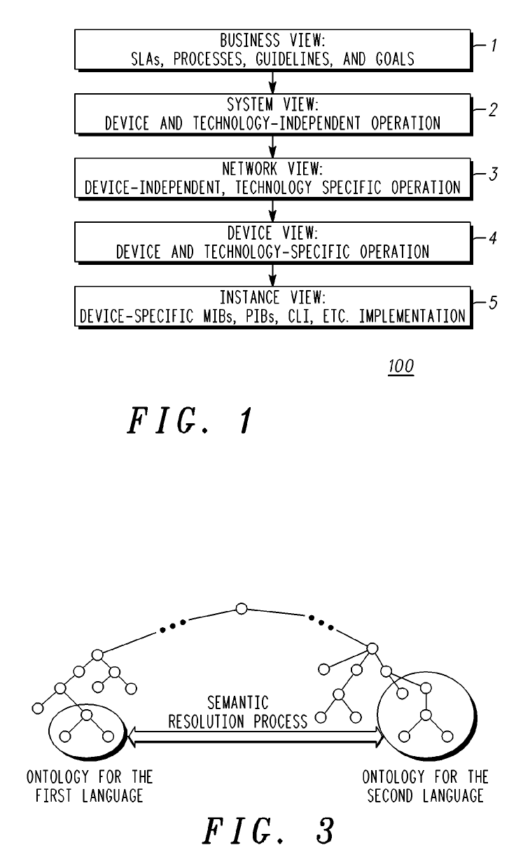

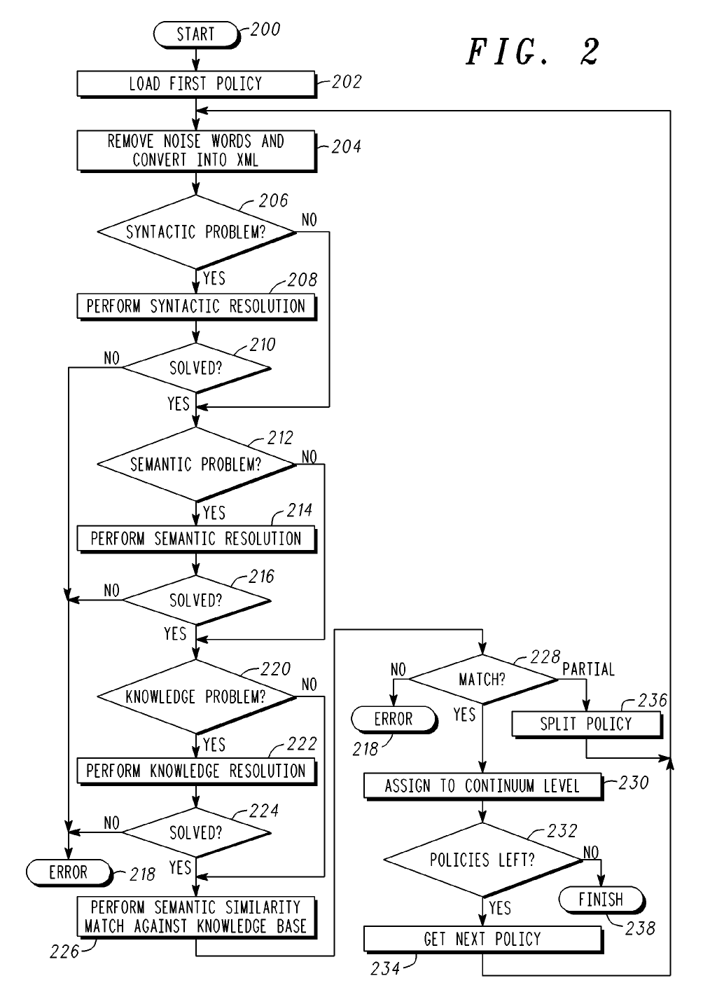

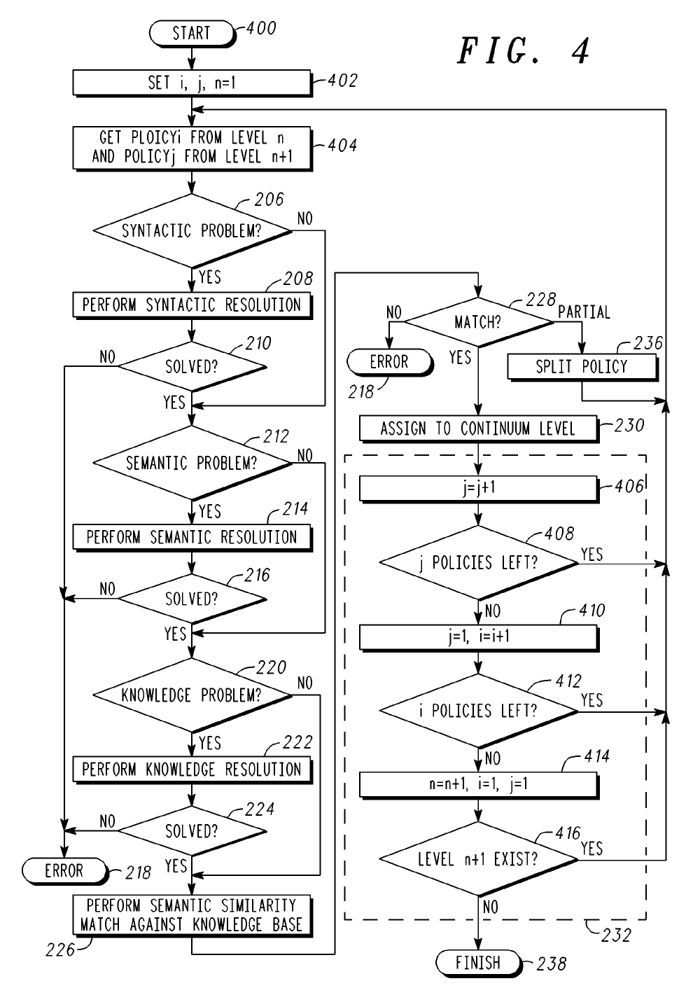

Checking for semantic problems is done as follows. First, one or more ontologies are used to map language elements of each of the policy statements of the policy to a universal vocabulary represented by the set of ontologies. Since an element of the policy language could potentially have more than one meaning, a semantic analysis is done to establish a single meaning that each language element has in the policy (note that this may include look ahead past a single policy statement, since multiple policy statements might depend on each other). Similar to the syntactic checking process of step 208, this process views the set of ontology concept elements as the ultimate source of truth, and attempts to correct the language representation. If no problems are found, the process moves to step 220 to look for knowledge problems. However, if semantic problems are found, the process moves to step 214 where semantic resolution is performed. Semantic resolution is conceptually shown in FIG. 3.

Semantic problems indicate a mismatch in the behavior that the policies will assert. In order to find semantic problems, the events, conditions and actions that make up each of the two policies being examined must be completely understood. This invention has the advantage of using a controlled vocabulary and a controlled set of grammatical rules. That is, it is significantly simpler than natural language semantic analysis, because the vocabulary and grammar rules are known beforehand and are much simpler. Essentially, the information model objects and ontological data provide one or more “indices” (or pointers) into the knowledge base that are collectively used to establish meaning.

Indices are used in different types of cognition theories to deduce meaning from the interaction of an entity with the entity that is being understood. In the present invention, words and phrases in each DEN-ng policy language are indexed to objects and concepts. Objects are defined by model elements in the information model; concepts are defined by elements in one or more ontologies. Note that knowledge obtained from the information model is augmented with knowledge obtained from the ontologies, producing a third form of knowledge that can be used to assign meaning to a policy.

At least two methods of semantic analysis are employed in accordance with embodiments of the present invention. The first is a matching function, based on language elements, keywords and metadata, that identifies words and phrases in the policy language with model elements (in the information model) and concepts (in the ontologies). The second is a semantic equivalence function that produces a ratioed result, enabling different matches to be rank-ordered. The first method is advantageous because of its smaller computational requirements; the second method, however, provides more completeness.

Each time the semantic analysis identifies that there are two or more meanings for a given language element, the system marks the analysis for further processing, in step 214, using one or more semantic resolution algorithms. An example of such an algorithm is described in A. Wong, P. Ray, N. Paramesh, J. Strassner, Ontology Mapping for the Interoperability Problem in Network Management, JSAC 2005 special publication on semantics, the entirety of which is included herein by reference. Simply put, a semantic resolution algorithm views the problem of defining a mapping between two language elements as equivalent to finding a mapping that equates the meaning of two different subgraphs that are not currently connected to each other, but which are part of an overall larger graph. This is shown in FIG. 3.

Essentially, the semantic resolution process performed in step 214 compares the meaning (i.e., not just the definition, but also the structural relationships, attributes, etc.) of each element in the first graph with each and every element in the second graph, trying to find the closest language element or elements that match the semantics of the element(s) in the first graph. Note that the comparison process includes one or more language elements from each graph. Often, an exact match is not possible, due to different meanings inherent in each language element; hence, the semantic resolution process provides a ratioed result, enabling each match to be ranked in order of best approximating the collective meaning of the first graph. As a consequence, the number of elements in the second subgraph, and the overall structure of the second subgraph, do not have to be the same (or even similar) to the number of elements and structure of the first subgraph. For example, when mapping two sets of commands to issue to two different network devices that use different languages, a set of different commands from one language may all be roughly equivalent, but not exactly the same, as one or more commands from the other language. Hence, by ranking each mapping, the system can choose the best mapping to use.

Hence, this stage consists of matching and/or translating language elements to one or more ontologies, ensure that the meaning of each policy is better understood. If resolution cannot be achieved, as is checked in step 216, the mechanism terminates with an error in step 218. Otherwise, and also for the case where no semantic problems are found in step 212, the process moves to step 220 and checks for knowledge problems.

Checking for knowledge problems is done as follows. First, each of the policy statements in the policy is modeled as a rigorous set of mathematical operations that describe the possible computations of each policy statement; then, the policy statements are analyzed to ensure that violations of the allowed mathematical operations do not occur. This stage checks to ensure that the intended behavior of each language statement is clear and unambiguous.

If a knowledge problem is detected in step 220 and cannot be resolved in step 222, then, in step 224, the process stops and an error is raised in step 218. Note that if any one policy statement causes this process to terminate with an error, then the entire policy is marked as invalid. Otherwise, the process moves to step 226 and performs a similarity match against the knowledge base.

This similarity match is used to establish a policy continuum level for the policy. Conceptually, this process evaluates the meaning, vocabulary, and grammar used by each policy language statement against a set of rules that define vocabulary, grammar, and meaning restrictions allowed for each policy continuum level. If a complete match is found, in step 228, then the policy is assigned to a (single) policy continuum level in step 230. A check is made in step 232 to see if additional Policies remain. If at least one policy remains, the process moves to step 234, where the next policy is retrieved and the flow moves back to step 204 where the process repeats for all of the remaining policies.

If a match is not found in step 228, then the process aborts with an error at step 218. However, if in step 228, a partial match is found, meaning that one or more elements of the policy statement have different mandatory policy continuum level assignments, the process moves to step 236 and splits the single policy into two or more Policies, each one containing its own set of policy statements that belong to the same policy continuum level. The process then moves back to step 204 and retries each of the split policies. An acceptable alternative to this is to simply abort with an error and seek human operator help.

FIG. 4 shows the flow of decisions according to an embodiment of the present invention. This takes the basic steps described in FIG. 2 above and adds a control loop, which ensures that all policies to be analyzed are semantically compared to each other. This semantic comparison ensures correct assignment of each policy to the proper policy continuum level, as well as splitting a policy into two or more policies that can each be assigned to a single policy continuum level. Again, each policy is divided into its constituent policy statements, and the process shown in FIG. 4 is applied for each of these policy statements. It is assumed here that a policy continuum already has been created (such as by the method shown in FIG. 2), that n is the number of layers, or levels, in the policy continuum (this was 5 in FIG. 1, but there is no restriction on the actual value of n used), and that there are i policies in layer n and j policies in layer n+1. Note also that, in principle, the reverse set of operations shown in FIG. 4 could be performed. That is, instead of starting at the most abstract level of the policy continuum and working down to the most detailed level of the policy continuum, this process could theoretically achieve the same result by starting at the most detailed level of the policy continuum and working up to the most abstract level of the policy continuum. We will describe the former because it is conceptually easier to understand and a preferred embodiment of this invention for most, but not all, cases.

The flow starts at step 400 and moves directly to step 402, where the mechanism is initialized by setting i, j, and n all equal to 1. The process then focuses, in step 404, on the first policy, i, in layer 1 and the first policy, j, in layer 2. The flow then moves to step 206. Steps 206 through 230 are the same as steps 206-230 as described above and shown in FIG. 2.

Steps 406 through 416 are sub-steps within steps 232 and 234 of FIG. 2. In step 406, j is incremented by 1. In step 408, a check is performed to determine whether or not any j policies are left. If the answer is yes, the flow moves back up to step 404. If the answer to the query in step 408 is no, the flow moves to step 410 where j is set back to 1 and i is incremented by 1. In step 412 a check is performed to determine whether or not any i policies are left. If the answer is yes, the flow moves back up to step 404. If the answer to the query in step 412 is no, the flow moves to step 414 where i is set back to 1, j is set to equal 1, and n is incremented by 1. The flow then moves to step 416 where a check is performed to determine whether or not any additional (n+1) levels exist. If the answer is yes, the flow moves back up to step 404. If the answer to the query in step 416 is no, the flow moves to step 238 where the process ends.

A problem is introduced by the attempt to bind different DEN-ng languages to their constituencies. This is partly due to the fact that the more abstract the DENng language is, the more it differs in appearance from the true root DEN-ng language. For example, noise words are introduced that make it easier for certain constituencies to understand, but don't change the nature of the word or phrase. FIG. 5 illustrates the semantic analysis used with certain embodiments of the present invention (e.g., step 212).

It should be noted that this mechanism has been drawn in a simplified form. The above flow is done for each policy in each Continuum level, similar to the iteration loop done for the syntactical analysis of FIG. 4. This has not been shown for the sake of simplicity. The process starts at step 500 and moves directly to step 502, where the mechanism pre-processes the raw policy to extract all non-essential (i.e., words and phrases that the DEN-ng language compiler has placed into the DEN-ng language). For example, the lowest DEN-ng language might have the following construct: Set John GoldService. This could get translated (one or more times) to the following form: The Customer John has just purchased our GoldService offering. There is no difference between these sentences (assuming that John is unique) from the DEN-ng engine point-of-view: John is an instance of the Customer class, and an association linking John to an instance of the GoldService class is built. However, the second form is much easier for business people to understand. The second form shows both noise words (“The Customer”, “just”, “our”, “offering”) and grammar layer translations (since the target is the business language, translate “set” to “has purchased”).

It should be noted that “customer” may not always be a noise word. This could even be true of “our”, since it could be used to differentiate native services from subcontracted services. The present invention, according to one embodiment, uses a novel ontology mapping approach that determines whether a given word is indeed a noise word or not. The inputs to this approach are the policy continuum level, the policy (not just a policy statement, because often, the context of more than one policy statement is needed), and the entire common vocabulary. This process first checks each element of the policy with only that portion of the common vocabulary that corresponds to the policy continuum level against which the policy is supposed to be targeted at. This allows the system to pre-load a set of patterns (e.g., “CREATE POLICY NAMED < >”, where “CREATE POLICY NAMED” are noise words that make it easier for the business user to know that the statement is creating a policy, and that the user must supply a name for it), simple noise words (e.g., “the”) that never add semantic meaning to the policy statement (but make it more readable), and possible noise words (e.g., “Customer” or “our”, as used above). A combination of pattern matching and semantic matching will then be used to determine the actual noise words used in any given policy statement. Note that different patterns are assigned to different policy continuum layers; this is why step 204 is required to strip out such patterns in order to be able to parse the content of the policy correctly.

This pre-processing is very important for a number of reasons. For the purposes of this disclosure, two important examples are that many noise words, as well as tense (“has purchased”) cannot be represented easily in UML. In step 502, these constructs are removed, otherwise the process may not be successful. In essence, the pre-processing strips out all operations done to the original, lowest-layer DEN-ng language that do not add semantic meaning, so that only the important grammatical elements (for that particular policy continuum level) remain.

Step 506 parses the actual policy, looking for specific content that is not either of a noise word or phrase or an artificial pattern. The parsing step looks only at content words, and sets all such content aside in lexical order in order to further analyze the policy. A check is then performed in step 508 for errors or warnings. For example, a new word that is not in the vocabulary could have been discovered. Such a case can be allowed, but requires user interaction (e.g., to supply a definition and relationships to the new word). If either is detected, the process moves to step 510, where an error message is generated. If neither is present in step 508, the process moves to step 512.

At this point, in step 512, the mechanism starts with the first lexeme that was parsed in step 506. (Note that the mechanism can also be done in parallel—that is, for each lexeme parsed, the second half of the mechanism can be run.) The mechanism first attempts, in step 514, to match the first lexeme to one or more model elements. (Note that a model element is any meta-class instance, including classes, relationships, constraints, and so forth.) This can be done by any number of pattern matching mechanisms. If the model element is found, then the immediate neighbors of that model element are identified in step 516, since it is likely, due to locality of reference, that other model elements (e.g., classes, attributes, associations, constraints, and so forth) that are associated with or part of the just identified model element will be referenced. If the answer to the query in step 514 is no or the answer to the query in step 518 is yes, the process moves to step 526.

Note that in general, a given model element may have many different associations to many other different model elements. This is exacerbated when the lexeme matches a number of model elements, since each model element in the match may have multiple associations. While one embodiment could continue searching among the different immediate associations of the matched model elements, a preferred embodiment is shown in FIG. 5, where at this point, when all directly connected associations of the matched model elements have been identified, the preferred embodiment uses semantic augmentation to identify those associations leading to other model elements that relate to the policy being analyzed.

Therefore, the mechanism sees if it can enrich the just-identified match by searching for a concept link in step 518. There are many ways to do this—for example, in step 526 a list of concepts could be contained in one or more data structures and identified using, for example, pattern matching or any number of linguistic-based searching mechanisms. Once all concepts are identified, semantic analysis is performed in step 528.

This semantic augmentation is important for finding behavioral conflicts and mismatches between two policies at two different layers. In addition, semantic augmentation is used to eliminate selecting different associations and model elements that have no relevance to analyzing the current policy. The semantic augmentation can be performed by any semantic equivalence mechanism, such as that described in the following paper: Ontology Mapping for the Interoperability Problem in Network Management.

The output of step 528 is a set of concepts and relationships between those concepts, which are at different levels of abstraction than the knowledge contained in the model elements. Now, in step 530, the mechanism attempts to link knowledge from those model elements to knowledge in the ontologies. This enables each of the policy language elements to be better understood. Note that the DEN-ng model also embeds metadata in each model element that can be used to help this part of the mechanism. If the match is successful, one or more lexemes of greater abstraction can be built, as shown in step 532. This then proceeds to step 522, and the next lexeme is obtained. If the match is unsuccessful, then the mechanism then searches for additional lexemes in step 520. If additional lexemes exist, the process moves to step 522 and continues through all lexemes until the policy is completely parsed. If, on the other hand, no additional lexemes exist, the process moves to step 524 and ends.

An important side effect of this mechanism is that even if no problems and/or conflicts are found, greater understanding of the policy has been obtained. This is important for the next step of this invention.

The mechanism of FIG. 5 is completed for each pair of policies that are to be semantically checked, as shown in FIG. 4. If the set of policies to be translated have not been previously validated by the method shown in FIG. 4, then that method must first be run, to ensure that the policies to be translated are indeed verifiably correct policies. If there are problems and/or conflicts found, then they are corrected and the mechanism is re-run.

If no such problems and/or conflicts are found, then we can reuse the above processes to provide translation between different policies at different levels of the policy continuum. This is done by using the combination of information models and ontologies to identify language elements in the policy statements that make up the different policies that have the same or similar meaning. This can be done, because the DEN-ng languages are derived from a set of verifiable models and defined using a context-free grammar. This in turn enables applications to be designed that use the universal vocabulary and grammar provided by the combination of models and ontologies to define a set of translations between different elements of different language levels. The simplest of these is, of course, to enable translation between each level; however, this should not be used to limit the scope of this invention.

Policy System

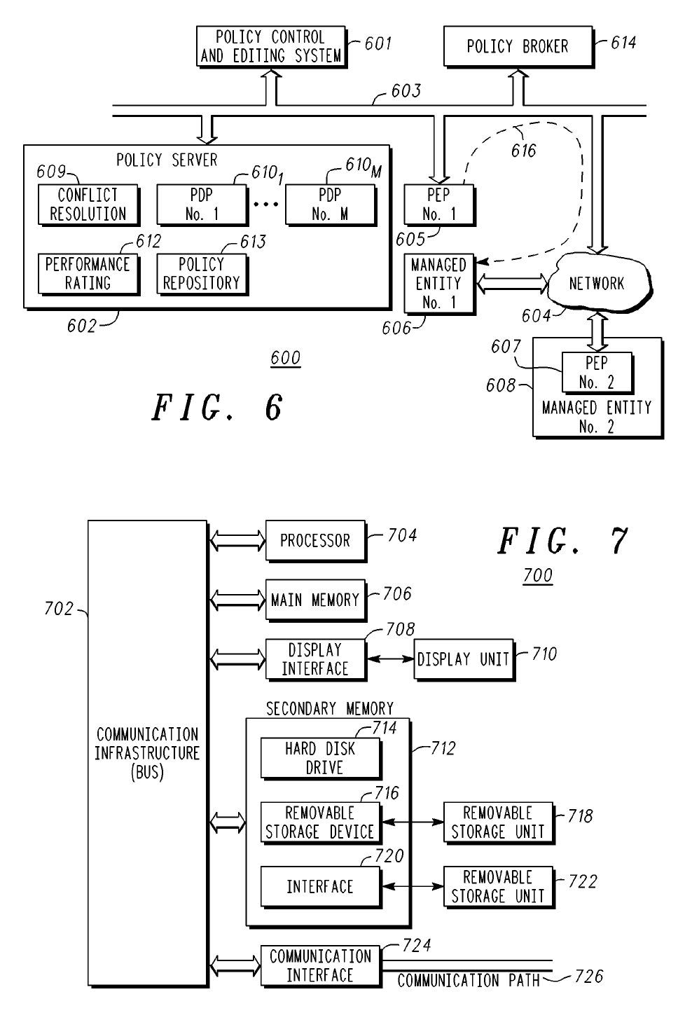

FIG. 6 illustrates a simple policy-based system 600 according to an embodiment and useful for implementing the present invention. Note that the simple nature of the example system shown in FIG. 6 does not constrain the present invention, which is capable of enhancing the operation of policy-based systems of large size and great complexity.

In FIG. 6, a policy control and editing system 601 receives, edits, and maintains policy rules. A policy server 602 actively manages the policy rules governing operation of the system. A policy system bus 603 connects the policy system components (e.g., stand-alone Policy Execution Points (PEPs) used to enforce and verify the actions of executing policies and connects the policy server 602 to the managed network 604. A first PEP 605 implements policy actions directed toward a first managed entity 606. In this example case, the first PEP 605 and the first managed entity 606 are separate and communicate via the policy system bus 603 and the network 604 as shown by the broken line 616.

A second PEP 607, implements policy actions (not shown) directed toward a second managed entity 608. In this case, the second PEP 607 is co-located within its corresponding managed entity 608.

The policy server 602 includes several components. A conflict resolution component 609 works to resolve conflicts between policy rules. A policy conflict occurs when the conditions of two or more policy rules that apply to the same set of managed objects are simultaneously satisfied, but the actions of two or more of these policy rules conflict with each other. One or more Policy Decision Points (PDPs) 610₁-610ₘ evaluate policy conditions that are targeted at specific domains, such as QoS and security. This addresses the most common existing and legacy deployments of policy management, wherein separate policy control is assigned to different functions to be managed. However, this should not limit the present invention, in that a single Policy Server 602′ (not shown) could be constructed using the mechanisms described in this invention to manage a plurality of different functions. In accordance with one embodiment of the present invention, a performance rating component 612 maintains the ordered list of policy rules and their performance ratings. In other embodiments, the performance rating component 612 may apply specified thresholds to policy rule performance, selectively calling operator attention to policy rules according to their performance. In other embodiments, the performance rating component 612 may respond to requests for input from the conflict resolution component 609 to help resolve policy rule conflicts. A policy repository component 613 is provided within the policy server 602 to store the policy rules. PEPs 605, 607 request policy decisions from PDPs 610₁-610ₘ; one or more of these PDPs 610₁-610ₘ will then respond to the PEPs 605,607 with the requested policy decision.

The policy-based system 600, in accordance with one embodiment of the present invention, also includes a policy broker 614. The policy broker 614 controls how different policy servers 602 interact with each other and ensures that conflicts do not exist between the policy servers 602. The policy broker 614 also coordinates the application of different policy rules in different policy servers 602.

Policy Server

FIG. 7 is a high level block diagram illustrating a detailed view of a computing system 700 useful for implementing the policy server 602 according to embodiments of the present invention. The computing system 700 is based upon a suitably configured processing system adapted to implement an exemplary embodiment of the present invention. For example, a personal computer, workstation, or the like, may be used.

In one embodiment of the present invention, the computing system 700 includes one or more processors, such as processor 704. The processor 704 is connected to a communication infrastructure 702 (e.g., a communications bus, crossover bar, or network). Various software embodiments are described in terms of this exemplary computer system. After reading this description, it will become apparent to a person of ordinary skill in the relevant art(s) how to implement the invention using other computer systems and/or computer architectures.

The computing system 700 can include a display interface 708 that forwards graphics, text, and other data from the communication infrastructure 702 (or from a frame buffer) for display on the display unit 710. The computing system 700 also includes a main memory 706, preferably random access memory (RAM), and may also include a secondary memory 712 as well as various caches and auxiliary memory as are normally found in computer systems. The secondary memory 712 may include, for example, a hard disk drive 714 and/or a removable storage drive 716, representing a floppy disk drive, a magnetic tape drive, an optical disk drive, etc. The removable storage drive 716 reads from and/or writes to a removable storage unit 718 in a manner well known to those having ordinary skill in the art. Removable storage unit 718, represents a floppy disk, a compact disc, magnetic tape, optical disk, etc. which is read by and written to by removable storage drive 716. As will be appreciated, the removable storage unit 718 includes a computer readable medium having stored therein computer software and/or data. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer-readable information.

In alternative embodiments, the secondary memory 712 may include other similar means for allowing computer programs or other instructions to be loaded into the policy server 102. Such means may include, for example, a removable storage unit 722 and an interface 720. Examples of such may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to the computing system 700.

The computing system 700, in this example, includes a communications interface 724 that acts as an input and output and allows software and data to be transferred between the policy server 102 and external devices or access points via a communications path 726. Examples of communications interface 724 may include a modem, a network interface (such as an Ethernet card), a communications port, a PCMCIA slot and card, etc. Software and data transferred via communications interface 724 are in the form of signals which may be, for example, electronic, electromagnetic, optical, or other signals capable of being received by communications interface 724. The signals are provided to communications interface 724 via a communications path (i.e., channel) 726. The channel 726 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 706 and secondary memory 712, removable storage drive 716, a hard disk installed in hard disk drive 714, and signals. The computer program products are means for providing software to the computer system. The computer readable medium allows the computer system to read data, instructions, messages or message packets, and other computer readable information from the computer readable medium.

Computer programs (also called computer control logic) are stored in main memory 706 and/or secondary memory 712. Computer programs may also be received via communications interface 724. Such computer programs, when executed, enable the computer system to perform the features of the present invention as discussed herein. In particular, the computer programs, when executed, enable the processor 704 to perform the features of the computer system.

### CONCLUSION

As should now be clear embodiments of the present invention provide an efficient method of determining a best ordering of policies to implement a service hosted on multiple resources or services (this latter takes into account service composition). It represents resources and services to be managed as a graph, and shows their dependency through either nested graphs or a set of pseudographs, multigraphs, and/or hypergraphs. The relationships between resources and services to be managed are defined by an information model and bound by one or more data models, ensuring extensibility, agility to add/remove capabilities, and to use code generation facilities to generate configuration code dynamically. The same information model is used to represent policies, thereby establishing inherent relationships between policies, services, and resources. In addition, this invention represents the underlying meaning of entities being modeled as one or more ontologies, and uses semantic reasoning to augment the knowledge obtained from the information and data models to better understand the intent of the policy author(s). This invention then constructs a policy continuum from the one or more policies supplied to it, and defines a set of mechanisms to manage the constructed policy continuum.

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for managing a policy, the method comprising:
accessing at least one policy, residing at a first abstraction level, where each policy includes a plurality of language elements in a first vocabulary set;
performing semantic resolution using a set of ontologies by mapping at least one of the language elements in the first vocabulary set to at least one of a plurality of language elements in a second vocabulary set, the second vocabulary set having at least one of a different grammar and a different vocabulary from the first vocabulary set; and
in response to the semantic resolution, creating a second policy that is related to the first policy.

2. The method of claim 1, further comprising:
performing syntactic resolution by mapping at least one of the language elements in the first vocabulary set to at least one of the language elements in the second vocabulary set using an information model associated with both the policy and the language elements in each of the first vocabulary set and the second vocabulary set.

3. The method of claim 2, further comprising:
performing syntactic resolution by mapping at least one of the language elements in the first vocabulary set to at least one of the language elements in the second vocabulary set using a data model associated with both the policy as well as the language elements in each of the first vocabulary set and the second vocabulary set.

4. The method of claim 1, wherein the semantic resolution includes prompting a user for input when assigning the language elements in the second vocabulary set to a level of abstraction.

5. The method of claim 4, wherein the level of abstraction is selected by the user.

6. The method of claim 1, wherein the semantic resolution includes assigning at least one subset of the language elements in the second vocabulary set to a new policy residing at one of the first abstraction level, the second abstraction level, or a third abstraction level, thereby splitting the policy into two policies.

7. The method of claim 1, wherein the semantic resolution includes using at least one of a matching function and a semantic equivalence function;
wherein the matching function is based on one or more of syntax, keywords, metadata, and other language elements, that identifies words and phrases in a language that the policy uses with model elements from at least one of an information and a data model and concepts in the set of ontologies;
wherein the semantic equivalence function produces a ratioed result thereby enabling different matches to be placed in rank-order; and
wherein the semantic resolution provides preferred choices from the vocabulary used in the policy to define which words or phrases in the second vocabulary should be used to match the intent of the words or phrases in the first vocabulary.

8. The method of claim 1, further comprising:
removing at least one of the language elements in the first vocabulary set based upon at least one of a lexical class in the language of the policy such that removal of the language element does not alter a meaning of the policy within a specified level of abstraction.

9. The method of claim 1, further comprising:
removing a set of language elements in the first vocabulary set based on pattern matching to at least one of a template for syntactical replacement, at least one concept in at least one ontology of the set of ontologies, and at least one model element in at least one of an information and a data model.

10. The method of claim 1, further comprising:
using a combination of syntactic and semantic resolution to jointly determine the set of language elements from the first vocabulary set to map to a set of language elements from a second vocabulary set, thereby creating a second policy.

11. A method for managing a policy, the method comprising:
modeling at least a first set of policies, all at one policy continuum level, as a set of mathematical operations that describe possible computations of each of the first set of policies;
modeling at least a second set of policies, all at a different policy continuum level than that of the first set of policies, as a set of mathematical operations that describe possible computations of each of the second set of policies; and
analyzing both the first set of policies and the second set of policies to ensure that a mapping between the mathematical operations of the first set of policies and the mathematical operations of the second set of policies exists without producing a conflict therebetween.

12. The method of claim 11, further comprising:
forming a complete policy continuum by accepting a policy which is at any level of the policy continuum and iteratively translating the policy to higher and lower levels of abstraction.

13. A system for managing a policy, the system comprising:
a memory adapted to store at least one policy, residing at a first abstraction level, where each policy includes a plurality of language elements in a first vocabulary set;
a processor communicatively coupled to the memory and adapted to:
perform semantic resolution using a set of ontologies by mapping at least one of the language elements in the first vocabulary set to at least one of a plurality of language elements in a second vocabulary set, the second vocabulary set having at least one of a different grammar and a different vocabulary from the first vocabulary set; and
create a second policy, in response to the semantic resolution.

14. The system of claim 13, wherein the processor is further adapted to:
perform syntactic resolution by mapping at least one of the language elements in the first vocabulary set to at least one of the language elements in the second vocabulary set using a data model associated with both the policy as well as the language elements in each of the first vocabulary set and the second vocabulary set.

15. The system of claim 13, wherein the semantic resolution includes prompting a user for input when assigning the language elements in the second vocabulary set to a level of abstraction.

16. The system of claim 15, wherein the level of abstraction is selected by the user.

17. The system of claim 13, wherein the semantic resolution includes assigning at least one subset of the language elements in the second vocabulary set to a new policy residing at one of the first abstraction level, the second abstraction level, or a third abstraction level, thereby splitting the policy into two policies.

18. The system of claim 13, wherein the semantic resolution includes using at least one of a matching function and a semantic equivalence function;
wherein the matching function is based on one or more of syntax, keywords, metadata, and other language elements, that identifies words and phrases in a language that the policy uses with model elements from at least one of an information and a data model and concepts in the set of ontologies;
wherein the semantic equivalence function produces a ratioed result thereby enabling different matches to be placed in rank-order; and
wherein the semantic resolution provides preferred choices from the vocabulary used in the policy.

19. The system of claim 13, wherein the processor is further adapted to:
remove at least one of the language elements in the first vocabulary set based upon at least one of a lexical class in the language of the policy such that removal of the language element does not alter a meaning of the policy within a specified level of abstraction.

20. The system of claim 1, wherein the processor is further adapted to:
remove a set of language elements in the first vocabulary set based on pattern matching to at least one of a template for syntactical replacement, at least one concept in at least one ontology of the set of ontologies, and at least one model element in at least one of an information and a data model.

21. The system of claim 1, wherein syntactic resolution is performed by mapping at least one of the language elements in the first vocabulary set to at least one of the language elements in the second vocabulary set using two or more data models associated with both the policy as well as the language elements in each of the first vocabulary set and the second vocabulary set; the differing definitions found in the two or more data models are resolved using the single information model.

22. The system of claim 1, wherein semantic resolution is performed by mapping at least one of the language elements in the first vocabulary set to at least one of the language elements in the second vocabulary set using two or more data models associated with both the policy as well as the language elements in each of the first vocabulary set and the second vocabulary set; the differing definitions found in the two or more data models are resolved using the single information model in conjunction with one or more ontologies.
